(19) United States
(12) Patent Application Publication
(10) Pub. No.: US 2006/0076715 A1
(43) Pub. Date: Apr. 13, 2006

(54) PROCESS FOR CREATING A LOW GLOSS SURFACE FINISH ON A VEHICLE TRIM COMPONENT

(76) Inventors: Jean-Jacques Katz, Novi, MI (US); Kenneth R. Parrish, Roseville, MI (US); Barry R. Wyerman, Novi, MI (US)

Correspondence Address: WOOD, HERRON & EVANS, LLP (LEAR), 2700 CAREW TOWER, 441 VINE STREET, CINCINNATI, OH, 45202, US

(21) Appl. No.: 10/711,821

(22) Filed: Oct. 7, 2004

(51) Int. Cl. H05H 1/26; B29C 67/00

(52) U.S. Cl. 264/483; 264/80

(57) ABSTRACT

Methods for reducing surface gloss of a vehicle interior trim component, such as non-carpeted floor coverings. Gloss is reduced by treating a surface of the interior trim component with an energy beam, such as a gas plasma, a flame plasma, or a corona discharge, emitted from a treatment device. A positioning device supports the treatment device in a spaced relationship to the surface. The positioning device causes the treatment device and the interior trim component to be moved relative to each other during the course of the gloss reduction treatment.

### FIELD OF THE INVENTION

The present invention generally pertains to vehicle interiors and more particularly to interior trim components for a vehicle that are characterized by low-gloss finishes, such as non-carpeted vehicle floor coverings.

### BACKGROUND OF THE INVENTION

A significant segment of the general market for vehicle flooring is migrating from carpeted to non-carpeted floor coverings. Non-carpeted floor coverings are formed from polymers with improved durability and cleanability when compared to carpeting. Such non-carpeted floor coverings have evolved from materials like polyvinyl chloride (PVC), which is quite heavy, tears easily, and is facing significant environmental and health challenges relating to its manufacture and disposal, to more engineered materials like thermoplastic polyolefins (TPO's).

A significant drawback of TPO's with desirable wear performances is the presence of a high gloss surface or shine. Associated with high gloss is an intrinsic slickness characterized by a low coefficient of friction (COF) with contacting objects, such as a driver's or passenger's shoe sole. Gloss can be controlled, or adjusted, by altering polymer composition to yield desired gloss levels of the end product. However, polymer modification is generally undesirable because other bulk properties of the floor covering may be negatively affected by such composition changes.

As a result, an apparatus and process is needed to reduce the surface gloss of interior trim components without chemical additives.

### SUMMARY OF THE INVENTION

In an embodiment of the invention, a method is provided for reducing surface gloss of a vehicle interior trim component. The method includes providing relative motion between an energy beam and the interior trim component, and treating the surface of the interior trim component with the energy beam during the relative motion of the energy beam and the interior trim component. The energy beam is effective for reducing the gloss of the surface.

By virtue of the foregoing, there is thus provided a process for reducing the surface gloss of non-carpeted vehicle floor coverings that does not affect the bulk properties of the material and that does not require chemical additives. Gloss reduction allows the surface finish of the floor covering to match, if required, the surface finish of other interior trim components.

These and other objects and advantages of the invention shall become more apparent from the accompanying drawings and description thereof.

### BRIEF DESCRIPTION OF THE DRAWINGS

The accompanying drawings, which are incorporated in and constitute a part of this specification, illustrate embodiments of the invention and, together with a general description of the invention given above, and the detailed description given below, serve to explain the principles of the invention.

FIG. 1 is a diagrammatic view of an apparatus for providing the surface treatment of the present invention for non-carpeted vehicle floor coverings;

FIG. 2 is a detailed view of a portion of a non-carpeted vehicle floor covering after surface treatment by the apparatus of FIG. 1; and

FIG. 3 is a diagrammatic view of the apparatus of FIG. 1 being used to treat sheet material used to make the floor coverings of the invention.

### DETAILED DESCRIPTION

The present invention is directed to a process for reducing the gloss or shine of a vehicle interior trim component composed of a polymer, or a blend of polymers, by modifying the surface of the component with a surface treatment. The invention is described with regard to polymer non-carpeted floor coverings. It will be understood that the present invention is not so limited as the process may be used to effectively reduce the surface gloss of other automotive interior trim components, such as instrument panels, consoles, door trim panels, glove box closures, etc, formed from a polymer or a polymer blend.

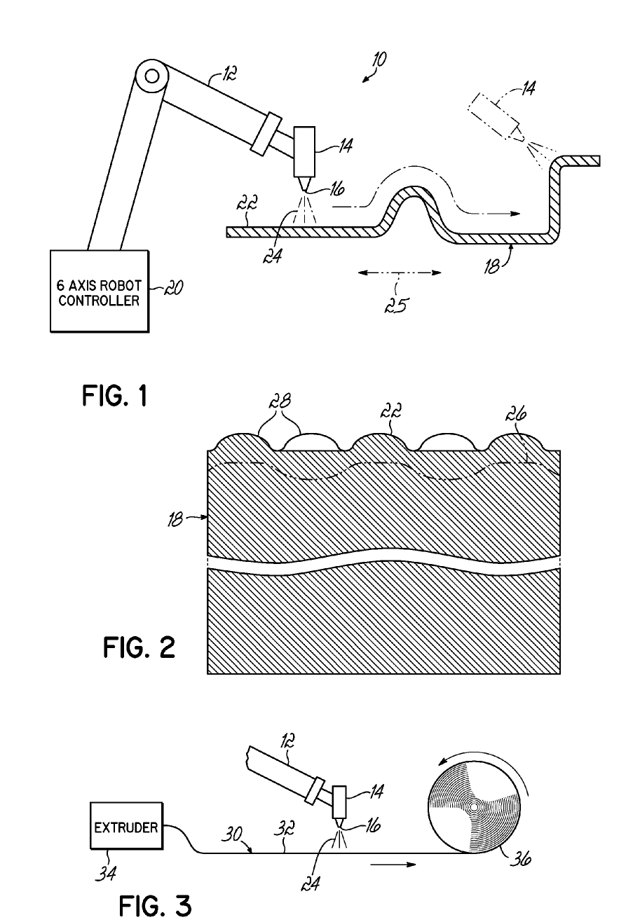

With reference to FIG. 1, the manufacturing system 10 of the present invention includes a positioning device, including a moveable robot arm 12, and a treatment device 14 located at the distal or free end of the arm 12. In a preferred embodiment of the invention, the moveable arm 12 is based on a conventional six-axis robot arm customized with links and joints, software, force sensors, and other features required for moving the treatment device 14 relative to the section of a formed sheet 18 of non-carpeted floor covering. The links, which are connected through the joints to actuators, move relative to one another in order to position the treatment device 14 in an X-Y-Z Cartesian coordinate frame. Hence, in the preferred embodiment, the robot arm 12 includes various joints and drive devices capable of motion for orienting an outlet 16 of the treatment device 14 relative to the formed sheet 18 in the X, Y and Z directions and can additionally rotate the outlet 16 of the treatment device 14 about the three axis directions. However, robot arms 18 having other constructions are contemplated by the present invention.

The motion commands for the robot arm 12 are supplied from a robot controller 20 coupled electrically with the drive devices of the robot arm 12. The invention contemplates that the positioning device may move the formed sheet 18 relative to the treatment device 14 in addition to the scanning of the treatment device 14 by robot arm 12. Preferably, however, the sheet 18 is stationary and the treatment device 14 is moved by the robot arm 12 relative to the sheet 18.

Due to the six-axis movement capability, the robot arm 12 is capable of accurately positioning the outlet 16 of the treatment device 14 relative to a surface 22 of the formed sheet 18 that will be visible once the formed sheet 18 is installed in a vehicle. The formed sheet 18 includes three-dimensional contoured features that may be highly non-planar. The robot arm 12, which scans the treatment device 14 across the surface 22 for treating the entire surface 22, is adapted to orient the outlet 16 of the treatment device 14 with a consistent orientation and a substantially constant separation distance relative to these contoured features. Maintaining these angular and spatial relationships between the outlet 16 and the surface 22 is important for ensuring uniform modification of surface 22 across its entire surface area.

The treatment device 14 is any device capable of emitting an energy beam 24 in an atmospheric pressure environment, yet compact enough to be coupled with robot arm 12 for movement relative to the formed sheet 18. The energy beam 24 is effective to condition formed sheet 18 by reducing the gloss or shine of surface 22 by an amount perceivable to an observer. The energy beam 24 may be the product of a corona discharge device, a flame-treatment device, a plasma treatment device, or any other oxidizing treatment device capable of emitting radiation in a range of the electromagnetic spectrum, such as ultraviolet wavelengths, microwave wavelengths, etc., effective for reducing the gloss of surface 22. Preferably, the robot arm 12 maintains the treatment device 14 oriented during scanning across the surface 22 such that the energy beam 24 impinges the surface with a normal angle of incidence.

In one embodiment of the invention, treatment device 14 may be any commercial gas flame treater, as will be known to those skilled in the art, having either high-velocity or ribbon burners capable of performing a flame plasma treatment effective to reduce the gloss of the visible surface 22 of the formed sheet 18, yet compact enough to be coupled with, and moved by, robot arm 12. Gaseous hydrocarbons like natural gas, liquefied natural gas (LNG), acetylene, ethane, propane, butane, isobutene, or liquefied petroleum gas (LPG) may be used as burner fuel. The plasma flame, which operates as the energy beam 24, provides an oxidation treatment of surface 22. Gas flame treatment systems suitable for use as treatment device 14 are commercially available from suppliers, such as Enercon Industries Corporation (Menomonee Falls, Wis.).

In another embodiment of the invention, treatment device 14 may be any commercial corona treater, as will be known to those skilled in the art, capable of performing a corona discharge treatment effective to reduce the gloss of the visible surface 22 of the formed sheet 18. The corona discharge is typically produced by applying a high voltage (approximately 5 to 10 kV) relatively high frequency (e.g. 10 kHz) signal to electrodes in air at atmospheric pressure. The corona discharge produced by the electrodes, which ionizes the air surrounding the electrodes, generates an electron stream emitted from outlet 16 toward surface 22 and, preferably, generally perpendicular to the surface 22 due to the positioning and orientation of the treatment supplied by the robot arm 12. The electron stream, which operates as the energy beam 24, provides an oxidation treatment of surface 22. Corona treatment systems suitable for use as treatment device 14 are commercially available from Corotec Corporation (Farmington, Conn.).

In yet another embodiment of the invention, treatment device 14 may be any commercial plasma pen or treater, as will be known to those skilled in the art, capable of performing a plasma treatment effective to reduce the gloss of the visible surface 22 of the formed sheet 18. The treatment device 14 may generate the plasma by creating an electrical discharge in an atmosphere of a working gas, such as neon, argon, krypton, oxygen and even air. The gas plasma includes charged particles and uncharged chemically-active radicals that interact with the surface 22. Exemplary atmospheric pressure plasma treatment systems suitable for use as treatment device 14 are disclosed in U.S. Pat. Nos. 5,837,958 and 6,677,550. The disclosure of each of these patents is hereby incorporated by reference herein in its entirety.

With reference to FIG. 2, the modification of the surface 22 of the formed sheet 18 extends to a treatment interface, indicated diagrammatically by reference numeral 26, having a relatively shallow penetration depth. As a result, the bulk properties of the sheet 18 (e.g., durability, wear resistance, flexibility, weight, etc.) are unaffected by the surface treatment supplied by the energy beam 24 from treatment device 14. A particularly useful thermoplastic for formed sheet 18 is a family of polymers, generally known as thermoplastic polyolefins (TPO's), although the invention is not so limited. Surface 22 may include a textured pattern of small projections or asperities 28 defined during the shaping process forming sheet 18 into its desired geometrical shape. The penetration depth of the treatment interface 26 will be influenced by the presence of the asperities 28. For example, sheet 18 may have a thickness of 0.5 mm to 2.0 mm, while the penetration depth of the treatment interface 26 will be only a few microns. It is appreciated that the treatment interface 26 may not be sharply defined, as recognized to be characteristic of such high-energy beam treatments by a person of ordinary skill in the art.

With reference to FIG. 3 and in accordance with an alternative embodiment of the invention, the robot arm 12 may be used to locate the outlet 16 of the treatment device 14 above and adjacent to one surface 32 of a bulk polymer sheet 30 destined to be shaped into formed sheets, like formed sheet 18, having a shape suitable for use as non-carpeted vehicle floor coverings. Untreated lengths of sheet 30 are extruded from a die head 34 and conveyed past the location of the treatment device 14. The motion of the sheet 30 may be periodically interrupted for scanning the treatment device 14 so as to modify the full width of the surface 32. The treated lengths of sheet 30 are wound onto a roll 36 and, subsequently, are delivered to another location for shaping by a forming process (e.g., vacuum- or thermo-forming) into formed sheets, like sheet 18 (FIG. 1), for use as non-carpeted floor coverings. Alternatively, the continuous length treated sheet 30 may be cut into separate blanks or sheets, before delivery to another location for forming into a shaped sheet 18. During forming, the treated surface 32 of sheet 30 is not contacted by the tool providing the forming process so that the surface treatment is preserved.

While the invention has been illustrated by the description of one or more embodiments thereof, and while the embodiments have been described in considerable detail, they are not intended to restrict or in any way limit the scope of the appended claims to such detail. Additional advantages and modifications will readily appear to those skilled in the art. The invention in its broader aspects is therefore not limited to the specific details, representative apparatus and methods and illustrative examples shown and described. Accordingly, departures may be made from such details without departing from the scope or spirit of Applicants' general inventive concept.

What is claimed is:

1. A method for reducing a surface gloss of a vehicle interior trim component, comprising:
moving an energy beam and the interior trim component relative to each other; and
treating a surface of the interior trim component with the energy beam during the relative motion of the energy beam and the interior trim component, the energy beam being effective for reducing the gloss of the surface.

2. The method of claim 1 wherein treating the surface of the interior trim component with the energy beam further comprises:
exposing the surface to a flame plasma.

3. The method of claim 1 wherein treating the surface of the interior trim component with the energy beam further comprises:
exposing the surface to a gas plasma.

4. The method of claim 1 wherein treating the surface of the interior trim component with the energy beam further comprises:
exposing the surface to a spray of electrons from a corona treatment.

5. The method of claim 1 wherein the interior trim component is stationary, and moving the energy beam and the interior trim component relative to each other further comprises:
scanning the energy beam back and forth relative to the surface.

6. The method of claim 1 wherein moving the energy beam and the interior trim component relative to each other further comprises:
maintaining a substantially constant separation between a source of the energy beam and the surface during relative movement.

7. The method of claim 1 wherein moving the energy beam and the interior trim component relative to each other further comprises:
maintaining a substantially angular orientation between a direction of the energy beam and a normal to the surface during relative movement.

8. The method of claim 1 further comprising:
shaping the interior trim component into a final contoured shape before treating the surface.

9. The method of claim 1 wherein the interior trim component is a non-contoured sheet for use as a non-carpeted vehicle floor covering.

10. The method of claim 1 wherein the interior trim component is a contoured sheet for use as a non-carpeted vehicle floor covering.

11. The method of claim 1 further comprising:
forming the interior trim component from a polymer.

12. The method of claim 11 wherein the polymer is a thermoplastic polyolefin.
